(19) United States
(12) Patent Application Publication
(10) Pub. No.: US 2011/0059626 A1
(43) Pub. Date: Mar. 10, 2011

(54) Shieled connector having leveling arrangement ensuring reliable interconnection

(75) Inventor: Feng Xu, Kunshan (CN)

(73) Assignee: HON HAI PRECISION INDUSTRY CO., LTD., Tu-Cheng (TW)

(21) Appl. No.: 12/807,566

(22) Filed: Sep. 7, 2010

(30) Foreign Application Priority Data
Sep. 7, 2009 (CN) 200920309723.4

(51) Int. Cl. H01R 13/648; H01R 12/00

(52) U.S. Cl. 439/55; 439/607.01

(57) ABSTRACT

A shield connector (100) includes a metallic shell (3) with a mating port (331) in communication with a mating receptacle with a tongue having a plurality of contact terminals (2) thereon. The contact terminals (2) include a plurality of solder tails (213, 223) extending out of the metallic shell (3). The metallic shell (3) defines a level arrangement (35) adjacent to the mating port (331) and defining a supporting plane coplanar to a mounting interface (5) of the shield connector (100).

### BACKGROUND OF THE INVENTION

1. Field of the Invention

The present invention relates to a shield connector, and more particularly to a shield connector having leveling arrangement ensuring reliable interconnection as well as mating capability.

2. Description of the Related Art

Nowadays, more and more electrical connectors has been designed so as to partially sunk into an opening of a printed circuit board (PCB) so as to meet the miniature trend. US Pat. Publication No. 2009/0130870 submitted by Wu et al. on Sep. 30, 2008, discloses a common sunk-typed connector mounted to a PCB for low profile. The connector includes an insulative housing, a plurality of contacts received in the housing and a metallic shell shielding insulative housing. The metallic shell is folded from a single sheet of metal so as to include a top wall, a bottom wall interconnected to the top wall by a pair of side walls. Each of the contacts includes a soldering tail extending outside of the insulative housing. The metallic shell defines a pair of soldering tails respectively extending from those two side walls and in parallel to the top wall or the bottom wall for soldering onto the PCB and helping the connector stood on the PCB. The connector is very much likely cantilevered from an edge of the PCB.

However, the soldering tails of the metallic shell is still arranged on the rear side of the electrical connector, i.e. most of the electrical connector is cantilevered from the PCB merely retained by solder joints of the soldering tails of the contacts soldered to the PCB. Once excessive mating force or inadvertently downward force is applied, those solder joints are under jeopardy and vulnerable to break apart. So the electrical connector will be turned over and unable to stand to the PCB steadily.

Therefore, an improved electrical connector is desired to overcome the disadvantages of the related arts.

### SUMMARY OF THE INVENTION

An object of the present invention is to provide a low profile shield connector steadily mounted to and properly supported on a PCB so as to ensure reliable interconnection thereof.

In order to achieve the above-mentioned object, a shield connector in accordance with a preferred embodiment of the present invention includes a metallic shell with a mating port in communication with a mating receptacle with a tongue having a plurality of contact terminals thereon. The contact terminals include a plurality of solder tails extending out of the metallic shell. The metallic shell defines a level arrangement adjacent to the mating port and defining a supporting plane coplanar to a mounting interface of the shield connector.

Other objects, advantages and novel features of the invention will become more apparent from the following detailed description of the present embodiment when taken in conjunction with the accompanying drawings.

### BRIEF DESCRIPTION OF THE DRAWINGS

FIG. 1 is a perspective view of a shield connector in accordance with the preferred embodiment of the present invention;

FIG. 2 is a perspective view of the shield connector of FIG. 1 assembled with a PCB;

FIG. 3 is an exploded perspective view of FIG. 1;

FIG. 4 is another exploded perspective view of FIG. 1 from a rear side view;

FIG. 5 is a side elevational view of FIG. 2; and

FIG. 6 is a side elevational view of the shield connector obliquely mounted onto the PCB in which a mating port thereof is lifted upward slightly.

### DETAILED DESCRIPTION OF THE INVENTION

Reference will now be made to the drawing figures to describe the preferred embodiment of the present invention in detail.

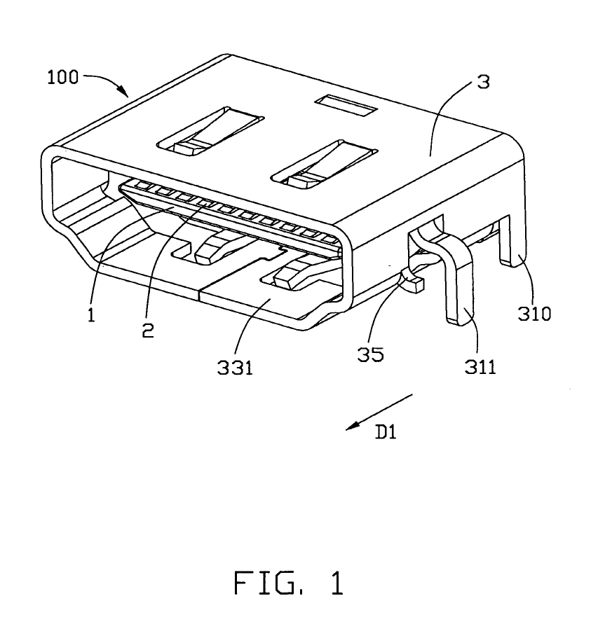

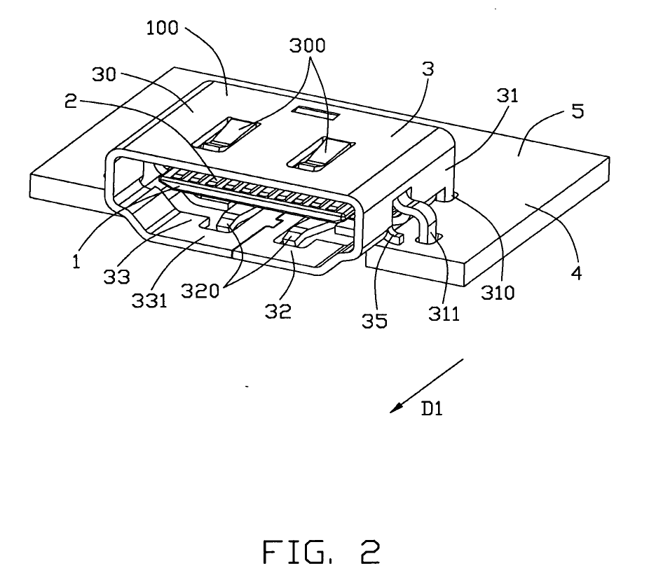

Referring to FIGS. 1 and 2, a shield connector 100 in accordance with the present invention is a low profile connector in which the connector is spanned over an opening of a printed circuit board (PCB) 4 such that the lower portion of the connector is coplanar to a low surface of the PCB 4 so as to reduce the overall height above the PCB 4. The shield connector includes an insulative housing 1 with a plurality of contact terminals 2 assembled therein and a metallic shell 3 surrounding the insulative housing 1.

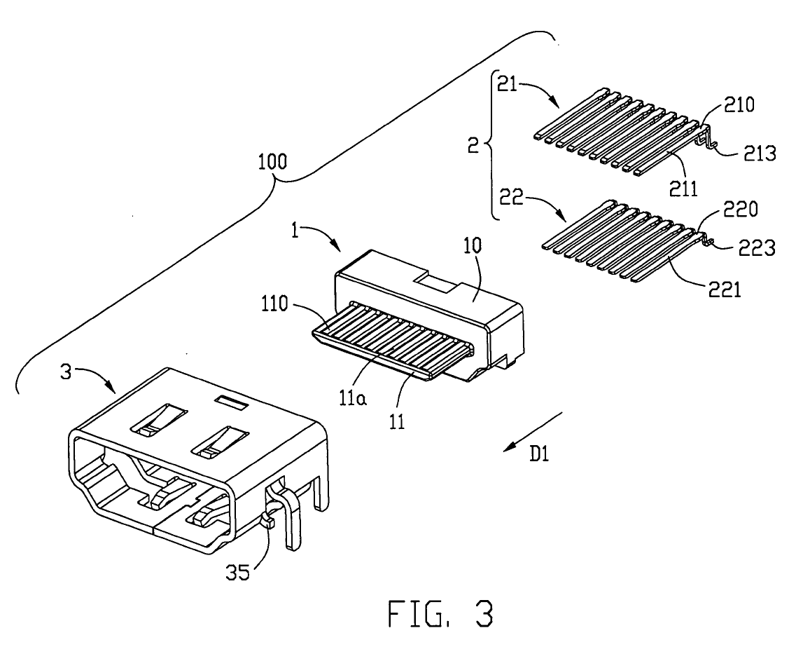

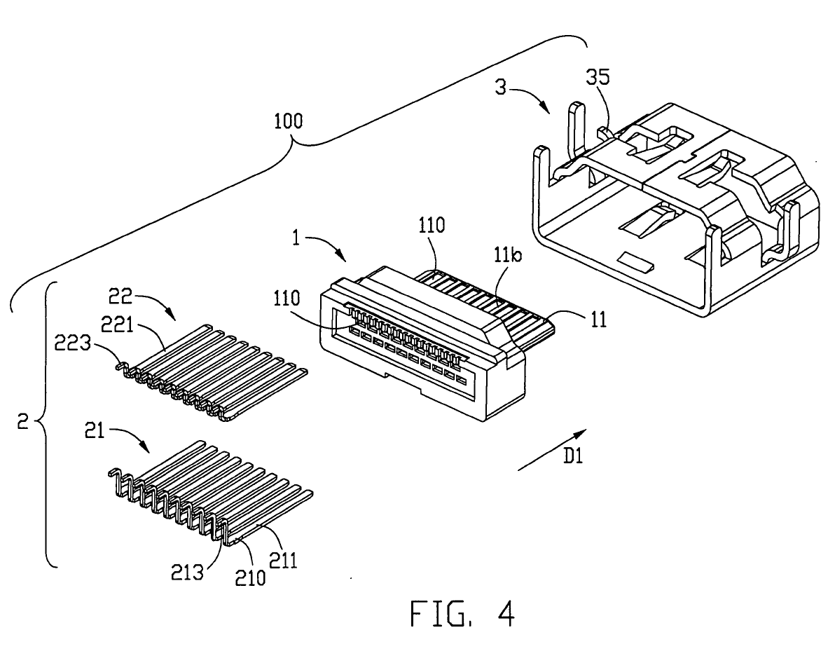

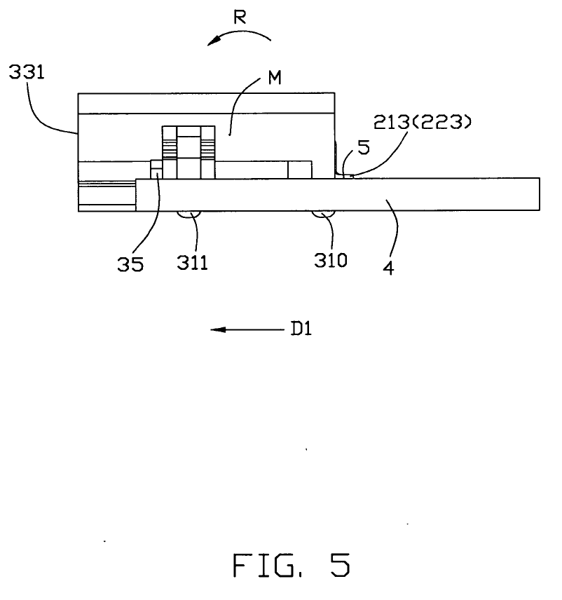

Referring to FIGS. 3 to 5, the insulative housing defines a body portion 10, an engaging portion 11 extending from the body portion 10 and a plurality of receiving grooves 110 extending through the body portion 10 and the engaging portion 11 along a rear-to-front direction (i.e. mating direction) as marked by arrow D1. The contact terminals 2 are inserted into the insulative housing along the D1 direction. The contact terminals 2 are grouped into a first set 21 and a second set 22 respectively settled down on an upper side 11a and a lower side 11b of the engaging portion 11, thereby forming a tongue-shaped configuration. Each of the first set contact terminals 21 includes a retaining portion 210 retained in the insulative housing 1, a contacting portion 211 extending from one end of the retaining portion 210 and a solder tail 213 extending outwards from another end of the retaining portion 210 for soldering onto the PCB 4. The second set contact terminals 22 have a configuration similar to the first set contact terminals 21, each of which includes a retaining portion 220, a contacting portion 221 and a solder tail 223. Additionally, the solder tails 213, 223 of the contact terminals 2 are coplanar to each other, thereby forming a plat interface which overlaps a mounting interface 5 of the shield connector 100 on the PCB 4.

Referring to FIGS. 2 and 3, the metallic shell 3 is assembled on the insulative housing 1 finally. The metallic shell 3 includes a top wall 30, a pair of side walls 31 interconnected with and perpendicular to the top wall 30 and a bottom wall 32 unitarily connecting with the side walls and opposite to the top wall 30, thereby forming a mating room 33 surrounding the engaging portion 11 with a mating port 331. The contacting portions 211, 221 are exposed to the mating room 33 for electrically connecting with a mating receptacle (not shown) inserted into the mating room 33. The top wall 30 has a pair of spring arms 300 opposite to a pair of spring arms 320 defined by the bottom wall 32 for clipping with said mating receptacle.

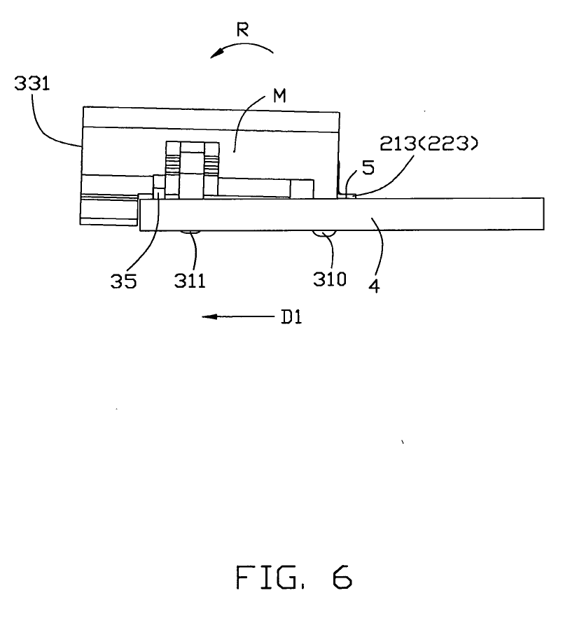

Referring to FIGS. 1, 2 and 5, each of the side walls 31 is provided with a first leg 310, a second leg 311 closer to the mating port 331 than the first leg 310 which are both connected with the PCB 4 (for example soldering or blocking with the PCB 4). The first and second legs 310, 311 are both perpendicular to the mounting interface 5 for extending through the PCB 4. A level arrangement 35 (or a standoff 35) is integrally arranged at each corner of the side wall 31 and the bottom wall 32 and defines a supporting plane which is coplanar to the mounting interface 5 for standing on the PCB 4. The level arrangements 35 are adjacent to the mating port 331. Furthermore, the level arrangements 35 are either soldered onto the PCB 4 or freely stand on the PCB for adjusting the position thereof conveniently. The overall height of the level arrangement 35 can be selectively designed to ensure the mounting interface 5 is coplanar to the PCB 4. For example, if the mating port 331 is to be lifted upward slightly or to any angle for intended purpose, then the level arrangement 35 can be lengthened or change its position to meet the requirement to properly support the mating port 331 above the printed circuit board 4 (as best shown in FIG. 6). The level arrangements 35 are closer to the mating port 331 than the first leg 310 and second leg 311 of the metallic shell 3 along the D1 direction, i.e. they are disposed at a front side of the center of gravity M of the shield connector 100. Furthermore, the solder tails 210 are located at a rear side of the center of gravity M. So the level arrangements 35 can prevent the connector 100 from turning over along a counterclockwise direction as marked by arrow R, viewed from right side of the connector 100. The shield connector will be steadily mounted to and properly supported on a PCB so as to ensure reliable interconnection thereof.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the board general meaning of the terms in which the appended claims are expressed.

What is claimed is:

1. A shield connector, comprising:
a metallic shell with a mating port in communication with a mating receptacle with a tongue having a plurality of contact terminals thereon, each contact terminal including a solder tail extending out of the metallic shell; and
wherein the metallic shell comprising a level arrangement adjacent to the mating port and defining a supporting plane coplanar to a mounting interface of the shield connector.

2. The shield connector as described in claim 1, wherein the metallic shell comprises a leg perpendicular to the supporting plane and arranged between the level arrangement and the solder tail.

3. The shield connector as described in claim 1, wherein the level arrangement of the metallic shell is closer to the mating port than the leg and the solder tail of the contact terminal, viewed from same side of the shield connector.

4. The shield connector as described in claim 3, wherein the metallic shell comprises a bottom wall is lower than the mounting interface of the contact terminal, a top wall opposite to the bottom wall which is higher than the mounting interface, thereby forming a sunk-in-board type connector.

5. The shield connector as described in claim 4, wherein the top wall and the bottom wall are interconnected to the top wall by a pair of side walls, in which the level arrangement is integrally arranged at each corner of the side wall and the bottom wall.

6. The shield connector as described in claim 3, wherein the leg comprises a first leg and a second leg both perpendicular to the mounting interface.

7. The shield connector as described in claim 6, wherein the second leg is closer to the mating port than the first leg.

8. An interconnecting system, comprising:
a printed circuit board (PCB) with a mounting area and a shield connector connecting with the PCB in sunk-in-board type, thereby forming a mounting interface coplanar to an upper side of the PCB;
the shield connector comprising an insulative housing with a plurality of contact terminals assembled therein and a metallic shell surrounding the insulative housing;
the contact terminals comprising a plurality of solder tails; and
wherein the metallic shell comprises a pair of level arrangements which are disposed on a front side of the center of gravity of the shield connector, the solder tails are located on a rear side of the center of gravity.

9. The interconnecting system as described in claim 8, wherein the level arrangements are either soldered onto the PCB or freely stand on the PCB for adjusting the position thereof conveniently.

10. The interconnecting system as described in claim 9, wherein the metallic shell comprising a leg extending through the PCB and disposed in the vicinity of the level arrangement.

11. The interconnecting system as described in claim 10, wherein the level arrangement and the solder tail are partitioned by the leg viewed from same side of the shield connector.

12. The interconnecting system as described in claim 9, wherein the metallic shell surrounds the engaging portion, thereby forming a mating port which is closer to the level arrangement than the solder tail of the contact terminal, viewed from same side of the shield connector.

13. An electrical connector assembly comprising:
an insulative housing;
a metallic shell essentially enclosing the housing with opposite top and bottom walls and opposite two side walls, and cooperating with the housing to define a front mating port and a rear mounting port thereof in a front-to-back direction; and
a plurality of contacts disposed in the housing, each of said contacts defining a front mating section exposed into the mating port and a rear mounting section horizontally extending around the mounting port and located at a middle level of said shell; wherein
the metallic shell defines at least a pair of standoffs respectively extending outwardly on said two side walls around said middle level in a vertical direction perpendicular to said front-to-back direction, and in front of said rear mounting sections of the contacts and essentially being coplanar with the rear mounting sections for commonly mounting upon an upper surface of a printed circuit board.

14. The electrical connector assembly as claimed in claim 13, wherein a bottom half portion of the shell with the enclosed housing is configured to be adapted to be snugly received in a notch of said printed circuit board.

15. The electrical connector assembly as claimed in claim 14, wherein said shell further defines a pair of mounting legs respectively on two side walls and offset from the corresponding pair of standoffs in said front-to-back direction for extending through corresponding through holes in said printed circuit board.

16. The electrical connector assembly as claimed in claim 15, wherein said mounting leg on each of said side walls is essentially located outside of the corresponding standoff in a lateral direction perpendicular to both said front-to-back direction and said vertical direction so as to assure the corresponding though hole in the printed circuit board is not close to the notch of the printed circuit board.

17. The electrical connector assembly as claimed in claim 15, wherein the mounting leg extends from a position of the corresponding side wall is higher than another position thereof where the corresponding standoff extends.

18. The electrical connector assembly as claimed in claim 15, wherein the standoff on each of said side walls is located in front of the corresponding mounting leg on the same side wall in said front-to-back direction.
